(19) United States
(12) Patent Application Publication
(10) Pub. No.: US 2018/0294956 A1
(43) Pub. Date: Oct. 11, 2018

(54) Systems and Methods for Data Backup and Authentication Using Blockchain

(71) Applicant: Walmart Apollo, LLC, Bentonville, AR (US)

(72) Inventors: John Jeremiah O'Brien, Farmington, AR (US); Brian Gerard McHale, Oldham (GB); Robert Cantrell, Herdon, VA (US); Donald Ray High, Noel, MO (US); Bruce W. Wilkinson, Rogers, AR (US); Todd Davenport Mattingly, Bentonville, AR (US)

(21) Appl. No.: 15/944,935

(22) Filed: Apr. 4, 2018

Related U.S. Application Data
(60) Provisional application No. 62/482,927, filed on Apr. 7, 2017.

(51) Int. Cl. H04L 9/06; G06F 11/14; H04L 9/32

(52) U.S. Cl. CPC H04L 9/0637; G06F 2201/805; H04L 9/3242; G06F 11/1464

(57) ABSTRACT

Exemplary embodiments of the present disclosure are related to a distributed blockchain storage system for data backup and authentication. Embodiments of the distributed blockchain storage system can include a computing system and at least one electronic system. The computing system generates sequential tasks and generates a first cryptographically verifiable ledger represented by a first sequence of blocks. The at least one electronic system generates a second cryptographically verifiable ledger, and in response to an unexpected termination of communication between the computing system and the at least one electronic system, perform one of execution of the last one of the plurality of sequential tasks or execution of exception handling.

### CROSS-REFERENCE TO RELATED PATENT APPLICATIONS

This application claims priority to U.S. Provisional Application No. 62/482,927 filed on Apr. 7, 2017, the content of which is hereby incorporated by reference in its entirety.

### BACKGROUND

In a communication or authentication system, when the primary system fails devices that must communicate and coordinate their activities can cease working. Therefore, a system for providing data backup for communication or authentication is needed.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 illustrates an exemplary distributed blockchain storage system for data backup and authentication in accordance with an exemplary embodiment of the present disclosure;

FIG. 2 comprises an illustration of blocks as configured in accordance with various embodiments of the present disclosure;

FIG. 3 comprises an illustration of transactions configured in accordance with various embodiments of the present disclosure;

FIG. 4 comprises a flow diagram in accordance with various embodiments of the present disclosure;

FIG. 5 comprises a process diagram as configured in accordance with various embodiments of the present disclosure;

FIG. 6 comprises an illustration of an execution record configured in accordance with various embodiments of the present disclosure;

FIG. 7 comprise a system diagram configured in accordance with various embodiments of the present disclosure;

FIG. 8 illustrates a block diagram an exemplary computing device in accordance with various embodiments of the present disclosure; and

FIG. 9 is a flowchart illustrating a process implemented by the distributed blockchain storage system in accordance with various embodiments of the present disclosure.

### DETAILED DESCRIPTION

Described in detail herein is a distributed blockchain storage system for data backup and authentication. Embodiments of the distributed blockchain system can be used to provide a reliable data system that prevents system failures form causing one or more devices in the system to abruptly stop functioning and to prevent the loos of data while ensuring the integrity and authenticity of the data in the system. For example, in one non-limiting example, embodiments of the distributed blockchain system can track execution record of an electronic system, such as, an autonomous vehicle that communicates with and receives instructions or commands from a remote system (e.g., a common control system (CCS) or command and control system (C2). The remote system can maintain the instructions or commands it sends to the electronic system in a blockchain and the electronic system can maintain its own blockchain based on the received instructions or commands. When the communication between the autonomous vehicle and the remote system is lost, or there is a lost link, the electronic system (e.g., autonomous vehicle) can refer to a block in the blockchain corresponding to the last-authenticated instruction or command and can determine whether to proceed to operate based on the content of the block based on learned or specified exception handling.

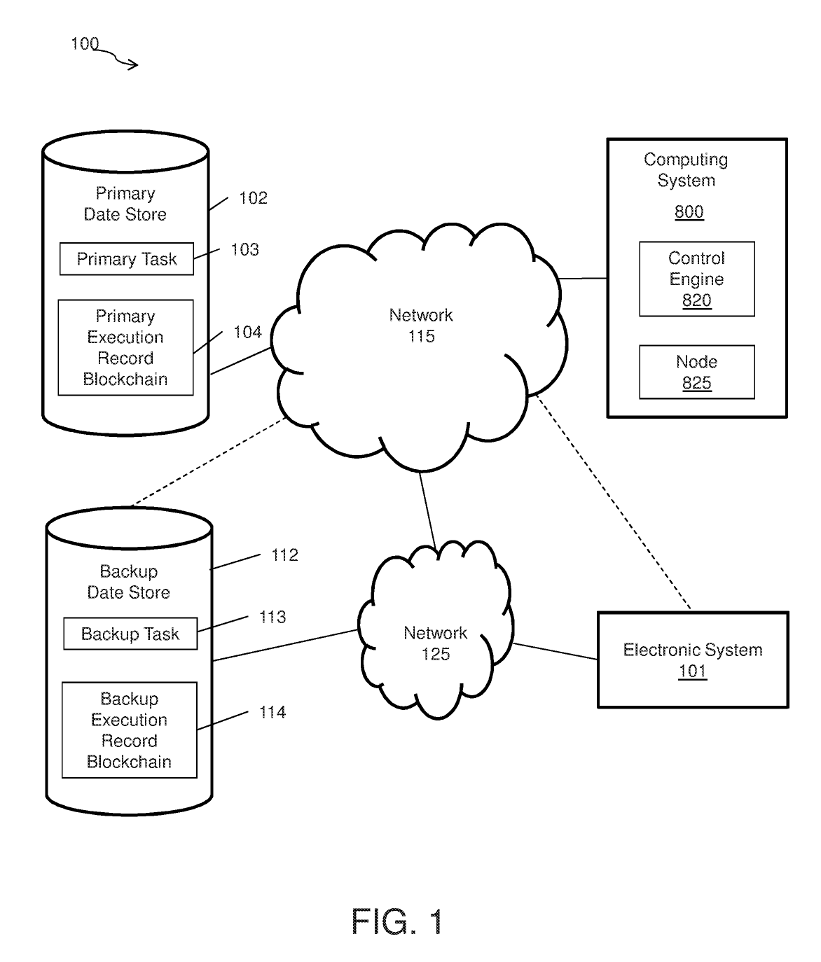

FIG. 1 illustrates an exemplary distributed blockchain storage system for data backup and authentication in accordance with an exemplary embodiment. The system can be implemented to provide authenticated and verifiable backup data financial records, government records, military records, and large data sets, instruction sets, and execution records. The distributed blockchain storage system 100 can include one or more electronic system 101, one or more primary data stores 102, one or more backup data stores 112, and one or more computing systems 800. The computing system 800 can communicate with the one or more primary data stores 102 via the network 115. The computing systems 800 and/or the primary data stores 102 can use digital circuits to facilitate the generation and storage of data (e.g., tasks and blocks), and the electronic system 101 and/or the backup data stores 112 can use analog circuits to generate and/or store data (e.g., tasks and blocks). The analog circuits can include, for example, organic molecules, quantum computing, nanotechnology, and the like, The electronic systems 101 can be in communication with the backup data stores 112 via the network 125 that is connected with the network 115, and therefore the electronic system 101 and the backup data store 112 can communicate with the computing system 800 and the primary data store 102 via networks 115 and 125. Alternatively, as shown by the dash lines, the electronic system 101 and the backup data store 112 can communicate with the computing system 800 and the primary data store 102 directly via the network 115. In some embodiments, the backup data store 112 can be integrated with the electronic system such that a network connection between the electronic system 101 and the backup data store 112 is not required. In some embodiments, the primary data store 102 can be integrated with the electronic system such that a network connection between the computing system 800 and the primary data store 102 is not required.

The one or more computing systems 800 can implement at least one instance of a control engine 820. The control engine 820 can be an executable application executed on the computing system 800. The control engine 820 can execute one or more processes of the distributed blockchain storage system 100 as described herein. The computing systems 800 can include one or more nodes 825. Each of the one or more nodes 825 can store a copy of a blockchain record and/or a shared ledger. The one or more nodes 825 can be configured to add the blocks in the blockchain record.

In an example embodiment, one or more portions of the communications network 115 and the communications network 125 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

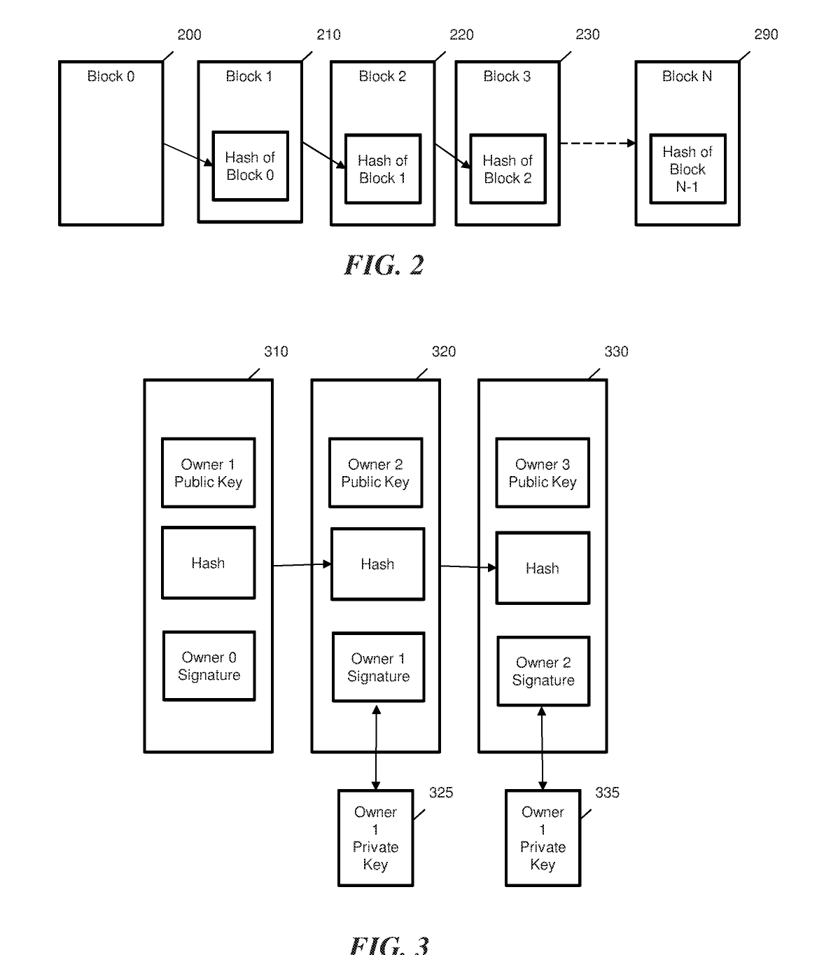

The computing system 800 includes one or more computers or processors configured to communicate with the electronic system 101 and the primary stores 102 (e.g., via the networks 115 and 125). The computing system 800 hosts one or more applications configured to interact with one or more components of the distributed blockchain storage system. The primary data store 102 and the backup data store 112 may store information/data, as described herein. For example, the primary stores 102 can store the primary tasks 103 and the primary execution record blockchain 104. The primary tasks 103 can include information associated with the tasks or missions submitted from the remote computing system 800 to the electronic system 101. The primary execution record blockchain 104 can be embodied as a blockchain system as described in FIGS. 2-7, configured to store a blockchain record or a shared ledger. The primary execution record blockchain 104 can include the execution record associated with the tasks executed by the electronic system 101.

Similarly, the backup data store 112 can store the backup tasks 113 and the backup execution record blockchain 114. The backup tasks 113 can include at least a subset of the primary task 103, i.e., at least a subset of the information associated with the tasks or missions received from the remote computing system 800. The backup execution record blockchain 114 can be embodied as a blockchain system as described in FIGS. 2-7, configured to store a blockchain record or a shared ledger. The backup execution record blockchain 114 can include at least a subset of the primary execution record blockchain 104, i.e., at least a subset of the execution record associated with the tasks executed by the electronic system 101.

In exemplary embodiments, the electronic system 101 can be, for example, an autonomous vehicle that executes the received task to perform one or more operations, such as driving in a particular direction, or stopping at a particular position. The computing system 800 can execute the control engine 820 in response to generate the tasks, transmit the tasks to the electronic system 101 and/or maintain the primary execution record blockchain 104. For example, the control engine 820 can store the primary tasks 103, and generate an execution record file for the task executed by the autonomous vehicle.

The execution record file can be stored as the primary execution record blockchain 104 or the backup execution record blockchain 114 using the distributed blockchain storage system as described in FIGS. 2-7. For example, the node 825 can generate a block in the execution record blockchain 104 and 114. The block can store the execution record. A private and public key can be associated with the block storing the execution record file. The node 825 can verify the public and private key of the block and provide access to the execution record file in response to verification. The node 825 can generate a subsequent block including transaction records of the other user successfully gaining access to the execution record file. A private key and public key associated to the subsequent block can be included in the subsequent block. In the event, an attempt is made to access the execution record file with an incorrect public and/or private key, the node 825 can restrict access to the execution record file. The node 825 can also generate a new block including transaction records associated with the failed attempt at accessing the execution record file.

Each new block created associated with accessing the execution record file can include a hash key associated with the previous block. This can be referred to as a chain. For example, in the event the block containing the execution record file is accessed, and a block is generated including transaction records associated the granted access. The new block can include a hash key of the block containing the execution record file. Side chains can also be created. For example, in the event there is a failed attempt to access the block containing the execution record file and the block is generated including transaction records associated with the failed access, the newly generated block can include a hash key of the block containing the execution record. However, the newly generated block may not include a hash key of the block including transaction records associated with the granted access to the block containing the execution record file. Accordingly, the block containing the execution record file can be linked in two different chains.

As an non-limiting example, an embodiment of the present disclosure can be implemented to facilitate operation of an autonomous vehicle (e.g., the electronic system 101) in response to a communication failure between the remote computing system 800 and the autonomous vehicle. The remote system generates sequential tasks to be executed by the autonomous vehicle. The computing system 800 can generate a primary data store 102 that stores the information associated with the received sequential tasks. The primary data store 102 includes primary tasks 103 which includes information representing each received task. The primary data store 102 further includes primary execution record blockchain 104 which includes the execution record of each task executed by the autonomous vehicle. When the electronic system 101 receives the sequential tasks, the autonomous vehicle can generate a backup data store 112 that stores the information associated with the last one task, or the last several tasks of the received sequential tasks (e.g., a summary blockchain). The backup data store 112 includes backup tasks 113 which includes information representing the last received task. The backup data store 112 further includes backup execution record blockchain 114 which includes the execution record of each last received task. When the autonomous vehicle executes the received sequential tasks, both the primary data store 102 and the backup data store 112 will be updated accordingly.

In the above distributed blockchain storage system, the communication between the electronic system 101 and the primary data store 102 can be digital communication, i.e., the primary task 103 and the primary execution record blockchain 104 are transmitted via digital transmission. The communication between the electronic system 101 and the backup data store 112 can analog communication, i.e., the backup task 113 and the backup execution record blockchain 114 are transmitted via analog transmission. Digital communications is the transfer of data over communication channel where binary or multi-symbol data is encoded in the transmission message. Analog communication is a transmission method that uses a continuous signal which varies in amplitude, phase, or some other property in proportion to that of a variable.

When the communication between the remote system and the autonomous vehicle is terminated or otherwise fails, new tasks cannot be transmitted to the autonomous vehicle. The autonomous vehicle executes the last task of the backup task 113 stored in the backup data store 112, and updates the backup execution record blockchain 114 accordingly. For example, the task may include instructions to navigate to a particular location and to capture images at the particular location. The autonomous vehicle can utilize exception handling to determine whether to perform the last received task in response to the failure in the communication between the computing system 800 and the autonomous vehicle. If the autonomous vehicle determines, that the task should not be completed, an exception handling process is implemented in which the autonomous vehicle performs a set of tasks. Otherwise, the autonomous vehicle performs the last received tasks, and subsequently performs the exception handling process. As one example, the exception handling process can include navigating to a specified location and waiting at the specified location until communications resume and/or until further instructions are received. After the communication between the remote system and the electronic system 101 resumes, the primary execution record blockchain 104 in the primary data store 102 can be updated according to the backup execution record blockchain 114, and then the remote system can continue to transmit sequential tasks to executed by the electronic system 101.

Descriptions of some embodiments of blockchain technology are provided with reference to FIG. 2-7 herein. In some embodiments of the invention described above, blockchain technology may be utilized to record execution of tasks. One or more of the electronic system described herein may comprise a node in a distributed blockchain system storing a copy of the blockchain record. Updates to the blockchain may comprise execution of tasks and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 2, an illustration of a blockchain according to some embodiments is shown. In some embodiments, a blockchain comprises a hash chain or a hash tree in which each block added in the chain contains a hash of the previous block. The blockchain can be maintained in the primary data store 102 by the computing system 800 as described with reference to FIG. 1 and/or can be maintained in the backup data store 112 by the electronic system 101. In FIG. 2, block 0 200 represents a genesis block of the chain and includes a first execution record associated with an operation of the electronic system in response to a first task. Block 1 210 contains a hash of block 0 200 and includes a second execution record associated with an operation of the electronic system in response to a second task. Block 2 220 contains a hash of block 1 210 and includes a third execution record associated with an operation of the electronic system in response to a third task. Block 3 230 contains a hash of block 2 220 and includes a fourth execution record associated with an operation of the electronic system in response to a fourth task, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of execution record of the electronic system.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners’ are nodes that compete to provide proof-of-work to form a new block, and the first successful miner of a new block earns Bitcoin currency in return.

Now referring to FIG. 3, an illustration of blockchain based records according to some embodiments is shown. In some embodiments, the blockchain illustrated in FIG. 3 comprises a hash chain protected by private/public key encryption. Record A 310 represents a task recorded in a block of a blockchain showing that electronic system 101 (recipient) obtained the task from the remote computing system (sender). Record A 310 contains the electronic system's public key and the remote computing system's signature for the record and a hash of a previous block. When the electronic system performs the operations associated with the task, a block containing record B 320 is formed. The record B 320 comprises the public key of the remote computing system 800 (recipient), a hash of the previous block, and the electronic system's signature for the transaction that is signed with the electronic system's private key 325 and verified using electronic system's public key in record A 310. The record B 320 can also include execution details associated with the task in record A 310. This process can be repeated for each task sent to the electronic system from the remote computing system and for each set of execution details generated in response to execution of corresponding tasks. In some embodiments, when each record is created, the system may check previous records and the private and public key signature of the electronic system and/or the computing system to determine whether the record is valid. In some embodiments, records are broadcasted in the peer-to-peer network and each node on the system may verify that the record is valid prior to adding the block containing the record to their copy of the blockchain. In some embodiments, nodes in the system may look for the longest chain in the system to determine the most up-to-date transaction record to prevent the current owner from double spending the asset. The records in FIG. 3 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

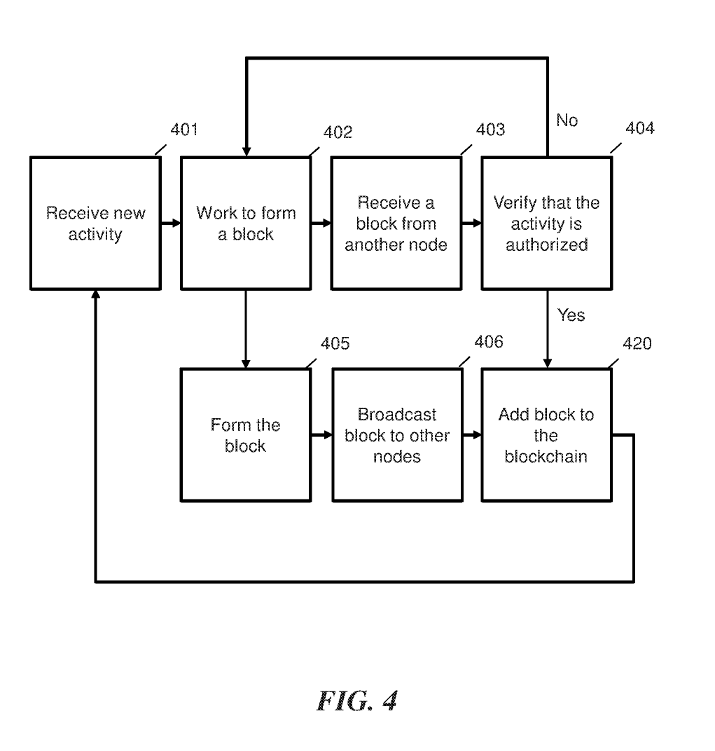

Now referring to FIG. 4, a flow diagram according to some embodiments is shown. In some embodiments, the steps shown in FIG. 4 may be performed by a processor-based device, such as a computer system, a server, a distributed server, a timestamp server, a blockchain node, and the like. In some embodiments, the steps in FIG. 4 may be performed by one or more of the nodes in a system using blockchain for record keeping, for example, the electronic systems.

In step 401, a node receives a new activity in response to the authentication of the electronic systems. The new activity may comprise an update to the record being kept in the form of a blockchain. In some embodiments, for blockchain supported digital or physical record keeping, the new activity can correspond to the authentication of the electronic systems and/or the transfer of the task from the remote system to the electronic systems. In some embodiments, the new activity may be broadcasted to a plurality of nodes on the network prior to step 401. In step 402, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 402, if the node successfully forms a block in step 405 prior to receiving a block from another node, the node broadcasts the block to other nodes over the network in step 406. In step 420, the node then adds the block to its copy of the blockchain. In the event that the node receives a block formed by another node in step 403 prior to being able to form the block, the node works to verify that the activity (e.g., authentication of transfer) recorded in the received block is authorized in step 404. In some embodiments, the node may further check the new block against system consensus rules for blocks and activities to verify whether the block is properly formed. If the new block is not authorized, the node may reject the block update and return to step 402 to continue to work to form the block. If the new block is verified by the node, the node may express its approval by adding the received block to its copy of the blockchain in step 420. After a block is added, the node then returns to step 401 to form the next block using the newly extended blockchain for the hash in the new block.

In some embodiments, in the event one or more blocks having the same block number is received after step 420, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 401.

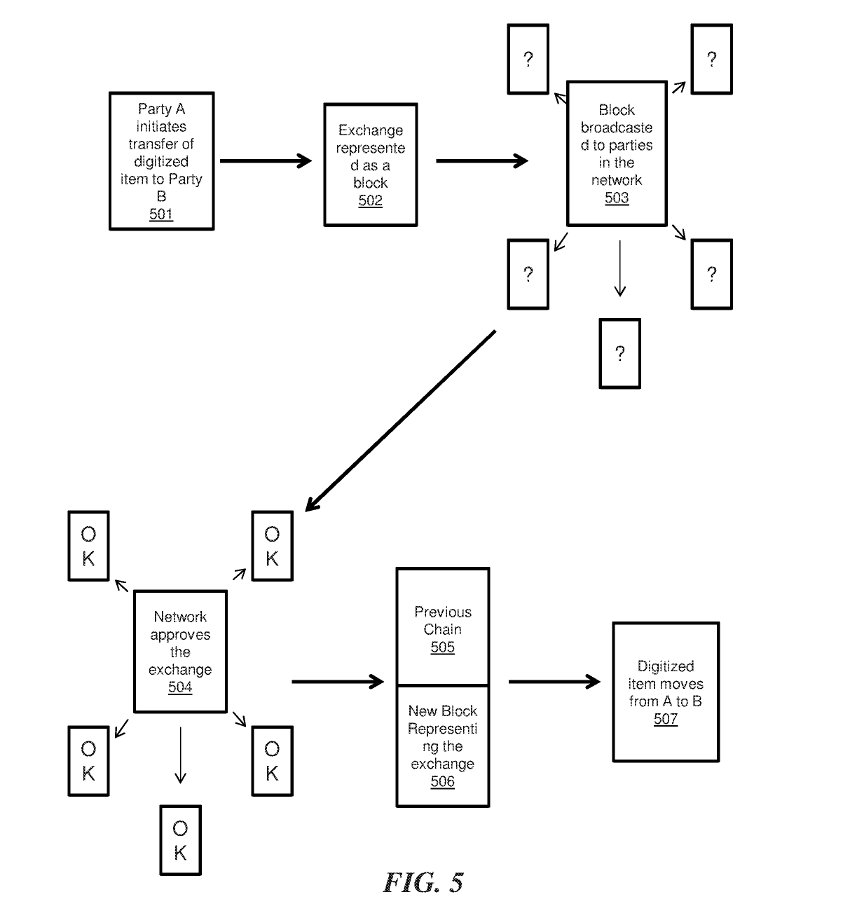

Now referring to FIG. 5, a process diagram a blockchain update according to some implementations in shown. In step 501, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 502, the exchange initiated in step 501 is represented as a block. In some embodiments, the transaction may be compared with transaction records in the longest chain in the distributed system to verify part A's execution record. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 503, the block is broadcasted to parties in the network. In step 504, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 506 representing the exchange is added to the existing chain 505 comprising blocks that chronologically precede the new block 506. The new block 506 may contain the transaction(s) and a hash of one or more blocks in the existing chain 505. In some embodiments, each node may then update their copy of the blockchain with the new block and continue to work on extending the chain with additional transactions. In step 507, when the chain is updated with the new block, the digitized item is moved from party A to party B.

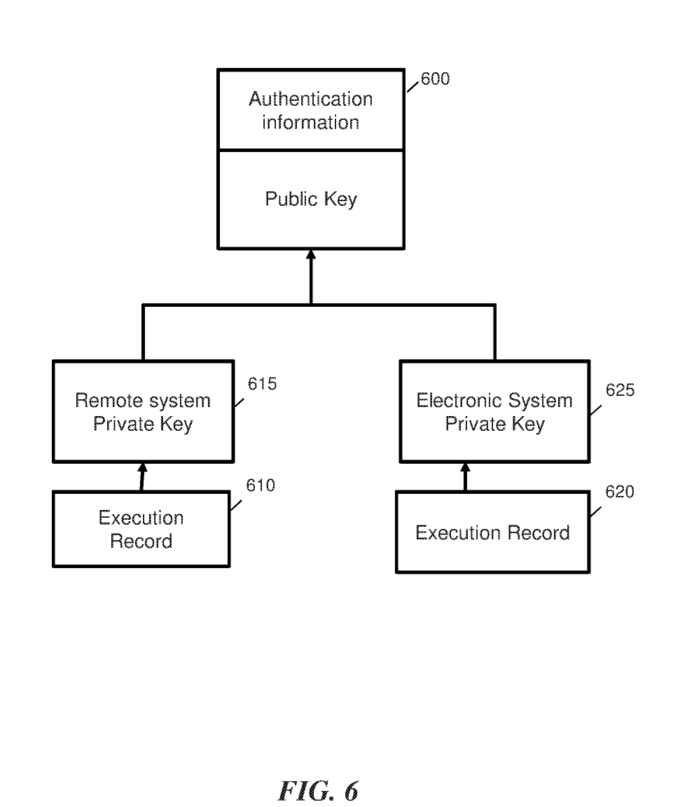

Now referring to FIG. 6, a diagram of a blockchain according to some embodiments in shown. FIG. 6 comprises an example of an implementation of a blockchain system for task execution record keeping. The execution record 600 comprises authentication information, transfer information, and a public key associated with one or more of the electronic system. In some embodiments, nodes associated with the remote system and the electronic system may each store a copy of the execution record 610 and 620, respectively. In some embodiments, the execution record 600 comprises a public key that allows the remote system and the electronic system to view and/or update the execution record 600 using their private keys 615 and 625, respectively. For example, when an task is transmitted from a remote system to the electronic system, the remote system may use the remote system's private key 615 to authorize the transmission of the task from the remote system to the electronic system and update the execution record with the new transaction. Similarly, when the execution record is being transmitted from the electronic system to the remote system, the electronic system may use the private key 625 to authorize the transmission of execution record from the electronic system to the remote system and update the execution record with the new transaction. In some embodiments, the transmission between the electronic system and the remote system can require that each of the electronic system and the remote system be authenticated, e.g., based on signatures from both the electronic system and the remote system using their respective private keys. The new transaction may be broadcasted and verified by the remote system, the electronic system, and/or other nodes on the system before being added to the distributed execution record blockchain.

With the scheme shown in FIG. 6, the execution record may be updated by one or more of the remote system and the electronic system to form a record of the transaction without a trusted third party while preventing unauthorized modifications to the record. In some embodiments, the blockchain based transactions may further function to include transfers of authentication information with the completion of the transmission of the execution record from the electronic system to the remote system. With the distributed database and peer-to-peer verification of a blockchain system, the remote system and the electronic system can confirm the authenticity and accuracy of the execution record stored in the form of a blockchain.

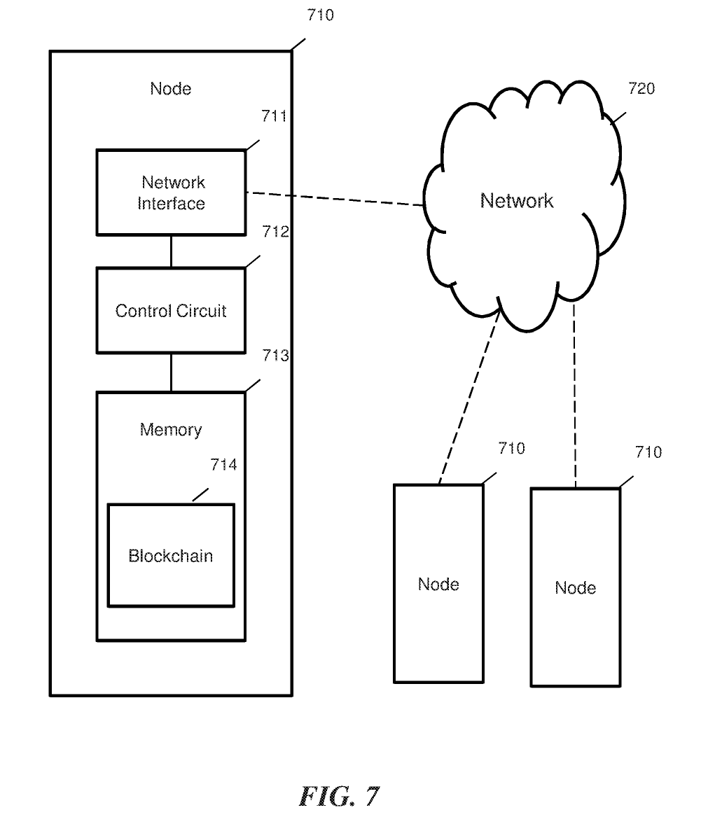

Now referring to FIG. 7, a system according to some embodiments is shown. A distributed blockchain system comprises a plurality of nodes 710 communicating over a network 720. In some embodiments, the nodes 710 may be comprise a distributed blockchain server and/or a distributed timestamp server. In some embodiments, one or more nodes 710 may comprise or be similar to a “miner” device on the Bitcoin network. Each node 710 in the system comprises a network interface 711, a control circuit 712, and a memory 713.

The control circuit 712 may comprise a processor, a microprocessor, and the like and may be configured to execute computer readable instructions stored on a computer readable storage memory 713. The computer readable storage memory may comprise volatile and/or non-volatile memory and have stored upon it a set of computer readable instructions which, when executed by the control circuit 712, causes the node 710 update the blockchain 714 stored in the memory 713 based on communications with other nodes 710 over the network 720. In some embodiments, the control circuit 712 may further be configured to extend the blockchain 714 by processing updates to form new blocks for the blockchain 714. Generally, each node may store a version of the blockchain 714, and together, may form a distributed database. In some embodiments, each node 710 may be configured to perform one or more steps described with reference to FIGS. 4-5 herein.

The network interface 711 may comprise one or more network devices configured to allow the control circuit to receive and transmit information via the network 720. In some embodiments, the network interface 711 may comprise one or more of a network adapter, a modem, a router, a data port, a transceiver, and the like. The network 720 may comprise a communication network configured to allow one or more nodes 710 to exchange data. In some embodiments, the network 720 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

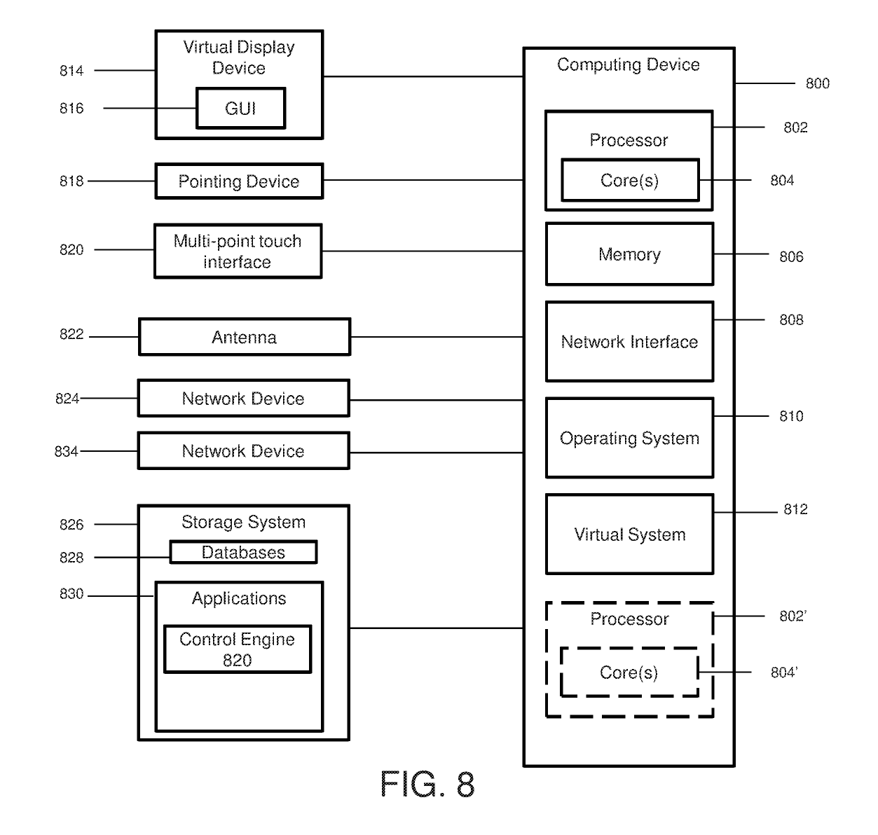

FIG. 8 is a block diagram of an example computing device for implementing exemplary embodiments of the present disclosure. Embodiments of the computing device 800 can implement embodiments of the distributed blockchain storage system. The computing device 800 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 806 included in the computing device 800 may store computer-readable and computer-executable instructions or software (e.g., applications 830 such as the control engine 820) for implementing exemplary operations of the computing device 800. The computing device 800 also includes configurable and/or programmable processor 802 and associated core(s) 804, and optionally, one or more additional configurable and/or programmable processor(s) 802′ and associated core(s) 804′ (for example, in the case of computer systems having multiple processors/cores), for executing computer-readable and computer-executable instructions or software stored in the memory 806 and other programs for implementing exemplary embodiments of the present disclosure. Processor 802 and processor(s) 802′ may each be a single core processor or multiple core (804 and 804′) processor. Either or both of processor 802 and processor(s) 802′ may be configured to execute one or more of the instructions described in connection with computing device 800.

Virtualization may be employed in the computing device 800 so that infrastructure and resources in the computing device 800 may be shared dynamically. A virtual machine 812 may be provided to handle a process running on multiple processors so that the process appears to be using only one computing resource rather than multiple computing resources. Multiple virtual machines may also be used with one processor.

Memory 806 may include a computer system memory or random access memory, such as DRAM, SRAM, EDO RAM, and the like. Memory 806 may include other types of memory as well, or combinations thereof. The computing device 800 can receive data from input/output devices such as, an image capturing device 834. The image capturing device 834 can capture still or moving images. A user may interact with the computing device 800 through a visual display device 814, such as a computer monitor, which may display one or more graphical user interfaces 816, multi touch interface 820 and a pointing device 818.

The computing device 800 may also include one or more storage devices 826, such as a hard-drive, CD-ROM, or other computer readable media, for storing data and computer-readable instructions and/or software that implement exemplary embodiments of the present disclosure (e.g., applications such as the control engine 820). For example, exemplary storage device 826 can include one or more databases 828 for storing information associated with representations of tasks and execution record associated with the representations of the task. The databases 828 may be updated manually or automatically at any suitable time to add, delete, and/or update one or more data items in the databases.

The computing device 800 can include a network interface 808 configured to interface via one or more network devices 824 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 822 to facilitate wireless communication (e.g., via the network interface) between the computing device 800 and a network and/or between the computing device 800 and other computing devices. The network interface 808 may include a built-in network adapter, network interface card, PCMCIA network card, card bus network adapter, wireless network adapter, USB network adapter, modem or any other device suitable for interfacing the computing device 800 to any type of network capable of communication and performing the operations described herein.

The computing device 800 may run any operating system 810, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device 800 and performing the operations described herein. In exemplary embodiments, the operating system 810 may be run in native mode or emulated mode. In an exemplary embodiment, the operating system 810 may be run on one or more cloud machine instances.

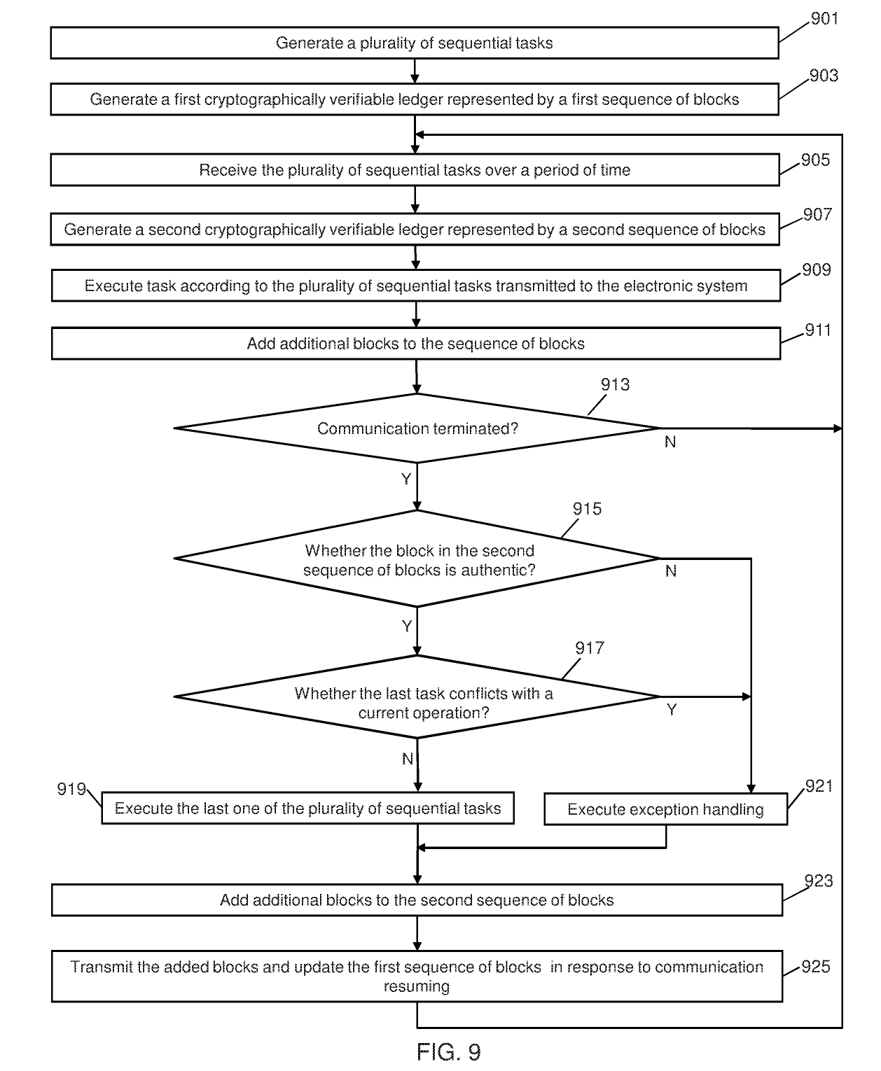

FIG. 9 is a flowchart illustrating the distributed blockchain storage system. At step 901 the system generates sequential tasks to be executed by the electronic systems, such as the autonomous vehicles. Then at step 903 the system generates a primary cryptographically verifiable ledger, i.e., a first cryptographically verifiable ledger represented by a first sequence of blocks. Each block contains one or more execution records associated with each of the sequential tasks, and each block contains a hash value associated with at least one previous block in the first sequence of blocks.

The electronic system then receives the sequential tasks over a period of time at step 905, and generate a backup cryptographically verifiable ledger, i.e., a second cryptographically verifiable ledger represented by a second sequence of blocks at step 907. The second sequence of blocks corresponds to at least a subset of the first sequence of blocks, which includes at least one block corresponding to the last task of the sequential tasks. At step 909, the electronic system executes tasks according to the sequential tasks, and then at step 911 add additional blocks to the second sequence of blocks according to the executed task.

At step 913, the system determines whether the communication is terminated, for example, whether the communication between the electronic system and the remote system is lost. When it is determined that communication is not terminated, the process goes back to step 905 where the electronic system continues to receive the sequential tasks. When the communication is terminated at step 913, the system further determines whether the at least one block in the second sequence of blocks, for example, the last block in the second sequence of blocks is authentic at step 915. If yes, at step 917 the system further determines whether the last task conflicts with a current operation of the electronic system. As the last block runs in parallel with the electronic system's blockchain-based AI and exception handling, this will allow the autonomous vehicle to accomplish the last received and authenticated blockchain task as long as it doesn't interfere with its learned blockchained-based AI and exception handling. Therefore, when there is no conflict, the autonomous vehicle will execute the last task of the sequential tasks at step 919. And then at step 923, the electronic system adds additional blocks to the second sequence of blocks according to the last executed task after the termination of communication.

Referring back to step 917, when the system determines the last task conflicts with the current operation of the electronic system, the electronic system will execute the exception handling process at step 921. Similarly, referring back to at step 915, when the system determines that the last block in the second sequence of blocks is not authentic, the process goes to step 921 where the exception handling process is executed. And then at step 923, the electronic system adds additional blocks to the second sequence of blocks according to the exception handling process executed by the electronic system.

At step 925, in response to communication with the C2 or CCS resuming, the electronic system transmits additional blocks added to the second sequence of blocks according to the last task executed by the electronic system after the termination of communication, and the first sequence of blocks is updated based on the additional blocks. Then the process goes back to step 905 where the system resumes transmitting the sequential tasks in response to communication resuming and receipt of the additional blocks.

In accordance with embodiments of the present disclosure, the system can create a summary sequence of blocks based on the first sequence of blocks, index the summary sequence of blocks of the first sequence of blocks, and generate a header of a new block to be concatenated to the first sequence of blocks based on the summary sequence of blocks. For example, the system can periodically create a “reader's digest summary” of the blockchain that must be agreed to by the members of block. Then the reader-digest summary can be used as a starting point for a new generation of the blockchain. With summary indexing to the supporting blockchain from which it was created, the summary provides a header for a next generation blockchain. This solves the problems of the blockchain getting too large over time, and eating up memory and processing time. This is also advantageous, for example, when the electronic system maintains the backup blockchain where storage and processing power may be limited or restricted. Allowing the electronic system to maintain a summary blockchain can allow the electronic system to use less storage and less processing power.

In some embodiments, the system for providing data backup for communication can be applied to smart appliances, as these devices may leverage the internet of things (TOT).

In another embodiments, the system can be used to add an additional layer of security, for example, the system can be used in Home closed-circuit television (CCTV) system to prevent hacking.

In accordance with embodiments of the present disclosure, for block chain use where authentication is the priority and history only need to be tracked backward so far, authentication is made with two block chain strings, instead of one block chain string. These strings are periodically reset, erasing the history of the giving strings, but these strings are never reset at the same time and a robust block chain is always in effect on at least one string. Rather than accumulating a mass of block chains, the system hops back and forth to truncate the required block chain strings. Therefore, in some embodiments, the system authenticates the at least one block based on two or more previous blocks of the second sequence of blocks, resets the second sequence of blocks to reduce a quantity of blocks in the second sequence of blocks, and when the second sequence of blocks is reset, at least one of the two or more previous blocks remain in the second sequence of blocks.

In some embodiments, the second sequence of blocks are transmitted via analog transmission, and the first sequence of blocks are transmitted via digital transmission.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A blockchain storage system for providing data backup for communication or authentication, comprising:
a computing system configured to:
generate a plurality of sequential tasks; and
generate a first cryptographically verifiable ledger represented by a first sequence of blocks, each block containing one or more execution records associated with a respective one of the plurality of sequential tasks, and each block containing a hash value associated with at least one previous block in the first sequence of blocks;
at least one electronic system for executing the plurality of sequential tasks, the at least one electronic system configured to:
receive the plurality of sequential tasks over a period of time, from the computing system;
generate a second cryptographically verifiable ledger represented by a second sequence of blocks, the second sequence of blocks corresponding to at least a subset of the first sequence of blocks including at least one block corresponding to a last one of the plurality of tasks to be received by the electronic system;
determine, in response to an unexpected termination of communication between the computing system and the at least one electronic system, at least one of whether the at least one block in the second sequence of blocks is authentic or whether the last one of the plurality of tasks conflicts with a current operation of the at least one electronic system, and
perform one of execution of the last one of the plurality of sequential tasks or execution of exception handling based on at least one of whether the at least one block in the second sequence of blocks is authentic or whether the last one of the plurality of tasks conflicts with a current operation of the at least one electronic system.

2. The system of claim 1, wherein at least one electronic system is further configured to execute exception handling in response to determining that the at least one block is not authentic or that the last one of the plurality of task conflicts with the current operation of the at least one electronic system.

3. The system of claim 1, wherein the computing system is configured to:
add additional blocks to the sequence of blocks in response to tasks executed by the at least one electronic system according to the plurality of sequential tasks transmitted to the at least one electronic system.

4. The system of claim 1, wherein in response to communication resuming, the at least one electronic system transmits additional blocks added to the second sequence of blocks according to the last one of the plurality of tasks executed by the at least one electronic system after the termination of communication, and the computing system updates the first sequence of blocks based on the additional blocks.

5. The system of claim 4, wherein the computing system resumes transmitting the plurality of sequential tasks in response to communication resuming and receipt of the additional blocks.

6. The system of claim 1, wherein the computing system is configured to:
create a summary sequence of blocks based on the first sequence of blocks;
index the summary sequence of blocks the first sequence of blocks, and
generate a header of a new block to be concatenated to the first sequence of blocks based on the summary sequence of blocks.

7. The system of claim 1, wherein the at least one electronic system is configured to:
authenticate the at least one block based on two or more previous blocks of the second sequence of blocks,
reset the second sequence of blocks to reduce a quantity of blocks in the second sequence of blocks,
wherein, when the second sequence of blocks is reset, at least one of the two or more previous blocks remain in the second sequence of blocks.

8. The system of claim 3, wherein the second sequence of blocks are transmitted via analog transmission, and the first sequence of blocks are transmitted via digital transmission.

9. A method for communicating with blockchain storage system for providing data backup for communication or authentication, the method comprising:
generating a plurality of sequential tasks; and
generating a first cryptographically verifiable ledger represented by a first sequence of blocks, each block containing one or more execution records associated with a respective one of the plurality of sequential tasks, and each block containing a hash value associated with at least one previous block in the first sequence of blocks;
receiving the plurality of sequential tasks over a period of time, from a computing system;
generating a second cryptographically verifiable ledger represented by a second sequence of blocks, the second sequence of blocks corresponding to at least a subset of the first sequence of blocks including at least one block corresponding to a last one of the plurality of tasks to be received by at least one electronic system;
determining, in response to an unexpected termination of communication between the computing system and the at least one electronic system, at least one of whether the at least one block in the second sequence of blocks is authentic or whether the last one of the plurality of tasks conflicts with a current operation of the at least one electronic system, and
performing one of execution of the last one of the plurality of sequential tasks or execution of exception handling based on at least one of whether the at least one block in the second sequence of blocks is authentic or whether the last one of the plurality of tasks conflicts with a current operation of the at least one electronic system.

10. The method of claim 9, further comprising:
execute exception handling in response to determining that the at least one block is not authentic or that the last one of the plurality of task conflicts with the current operation of the at least one electronic system.

11. The method of claim 9, further comprising:
adding additional blocks to the sequence of blocks in response to tasks executed by the at least one electronic system according to the plurality of sequential tasks transmitted to the at least one electronic system.

12. The method of claim 9, wherein in response to communication resuming, the at least one electronic system transmits additional blocks added to the second sequence of blocks according to the last one of the plurality of tasks executed by the at least one electronic system after the termination of communication, and the computing system updates the first sequence of blocks based on the additional blocks.

13. The method of claim 12, wherein the computing system resumes transmitting the plurality of sequential tasks in response to communication resuming and receipt of the additional blocks.

14. The method of claim 9, further comprising:
creating a summary sequence of blocks based on the first sequence of blocks;
indexing the summary sequence of blocks the first sequence of blocks, and
generating a header of a new block to be concatenated to the first sequence of blocks based on the summary sequence of blocks.

15. The method of claim 9, further comprising:
authenticating the at least one block based on two or more previous blocks of the second sequence of blocks,
resetting the second sequence of blocks to reduce a quantity of blocks in the second sequence of blocks,
wherein, when the second sequence of blocks is reset, at least one of the two or more previous blocks remain in the second sequence of blocks.

16. The method of claim 11, wherein the second sequence of blocks are transmitted via analog transmission, and the first sequence of blocks are transmitted via digital transmission.

17. A non-transitory computer-readable medium storing instructions that are executable by a processing device, wherein execution of the instructions by the processing device causes the processing device to:
generate a plurality of sequential tasks; and
generate a first cryptographically verifiable ledger represented by a first sequence of blocks, each block containing one or more execution records associated with a respective one of the plurality of sequential tasks, and each block containing a hash value associated with at least one previous block in the first sequence of blocks;
receive the plurality of sequential tasks over a period of time, from a computing system;
generate a second cryptographically verifiable ledger represented by a second sequence of blocks, the second sequence of blocks corresponding to at least a subset of the first sequence of blocks including at least one block corresponding to a last one of the plurality of tasks to be received by at least one electronic system;
determine, in response to an unexpected termination of communication between the computing system and the at least one electronic system, at least one of whether the at least one block in the second sequence of blocks is authentic or whether the last one of the plurality of tasks conflicts with a current operation of the at least one electronic system, and
perform one of execution of the last one of the plurality of sequential tasks or execution of exception handling based on at least one of whether the at least one block in the second sequence of blocks is authentic or whether the last one of the plurality of tasks conflicts with a current operation of the at least one electronic system.

18. The non-transitory computer-readable medium of claim 17, wherein at least one electronic system is further configured to execute exception handling in response to determining that the at least one block is not authentic or that the last one of the plurality of task conflicts with the current operation of the at least one electronic system.

19. The non-transitory computer-readable medium of claim 17, wherein execution of the instructions by the processing device causes the processing device to:
add additional blocks to the sequence of blocks in response to tasks executed by the at least one electronic system according to the plurality of sequential tasks transmitted to the at least one electronic system.

20. The non-transitory computer-readable medium of claim 17, wherein in response to communication resuming, the at least one electronic system transmits additional blocks added to the second sequence of blocks according to the last one of the plurality of tasks executed by the at least one electronic system after the termination of communication, and the computing system updates the first sequence of blocks based on the additional blocks.

21. The non-transitory computer-readable medium of claim 20, wherein the computing system resumes transmitting the plurality of sequential tasks in response to communication resuming and receipt of the additional blocks.

22. The non-transitory computer-readable medium of claim 17, wherein execution of the instructions by the processing device causes the processing device to:
create a summary sequence of blocks based on the first sequence of blocks;
index the summary sequence of blocks the first sequence of blocks, and
generate a header of a new block to be concatenated to the first sequence of blocks based on the summary sequence of blocks.

23. The non-transitory computer-readable medium of claim 17, wherein execution of the instructions by the processing device causes the processing device to:
authenticate the at least one block based on two or more previous blocks of the second sequence of blocks,
reset the second sequence of blocks to reduce a quantity of blocks in the second sequence of blocks,
wherein, when the second sequence of blocks is reset, at least one of the two or more previous blocks remain in the second sequence of blocks.

24. The non-transitory computer-readable medium of claim 19, wherein the second sequence of blocks are transmitted via analog transmission, and the first sequence of blocks are transmitted via digital transmission.
